(19) United States
(12) Patent Application Publication
(10) Pub. No.: US 2025/0330903 A1
(43) Pub. Date: Oct. 23, 2025

(54) PREFERRED RADIO ACCESS TECHNOLOGY ACQUISITION USING A CROWDSOURCING DATABASE

(71) Applicant: GOOGLE LLC, Mountain View, CA (US)

(72) Inventors: Zong Syun Lin, Hsinchu (TW); Tsu-Jou Shen, Hsinchu (TW); Chia-Wei Chang, San Jose, CA (US); Qin Zhang, Mountain View, CA (US)

(21) Appl. No.: 18/868,069

(22) PCT Filed: Jun. 14, 2023
(86) PCT No.: PCT/US2023/025307

§ 371 Date: Nov. 21, 2024

Related U.S. Application Data
(60) Provisional application No. 63/352,007, filed on Jun. 14, 2022.

(51) Int. Cl. H04W 48/20; H04W 48/04

(52) U.S. Cl. CPC H04W 48/20; H04W 48/04

(57) ABSTRACT

A user equipment (UE) sends location information to a crowdsourcing server that is configured to generate crowdsourced cell lists from neighboring cell lists received from one or more cellular networks. After receiving the location information from the UE, the crowdsourcing server selects a crowdsourced cell list for transmission based on the location information and transmits the selected crowdsourced cell list to the UE. In response to receiving the crowdsourced cell list, the UE compares the crowdsourced cell list to one or more stored neighboring cell lists to determine if the crowdsourced cell list identifies any cells not identified in the neighboring cell lists. From the cells identified in the crowdsourced cell list but not in the neighboring cell lists, the UE selects a cell to camp on based on an RAT priority list and camps on the selected cell.

### BACKGROUND

To determine which cellular networks are available for connection, user equipment (UE) uses neighboring cell lists received from cellular networks that identify cells of cellular networks potentially available for connection. From the neighboring cell lists, the UE selects a cell to camp on based on, in part, the radio access technology (RAT) preferences associated with the UE. That is to say, the UE selects a cell of a cellular network associated with an RAT that is preferred by the UE to camp on. However, neighboring cell lists received from some cellular networks do not list every cell potentially available for connection within an area. These omissions arise from network vendors not upgrading the RATs used by a cellular network, a lack of communication between cellular networks, and cellular networks not supporting handoffs to certain RATs, to name a few. Such omissions can result in the UE not being able to connect to a cellular network using a preferred RAT which can potentially lower data throughput, increase transmission latency, and negatively impact user experience.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a system configured for crowdsourced cell selection for user equipment (UE), in accordance with some embodiments.

FIG. 2 is a block diagram of a computing device configured for crowdsourced cell selection, in accordance with some embodiments.

FIG. 3 is a block diagram of an example framework for crowdsourced cell selection for UE, in accordance with embodiments.

FIGS. 4 and 5 together present a flow diagram of an example method for crowdsourced cell selection, in accordance with embodiments.

### SUMMARY OF EMBODIMENTS

Techniques and systems described herein are directed to user equipment (UE) selecting a cell of a cellular network to camp on based on a crowdsourced cell list. According to an example embodiment, a method for crowdsourced cell selection includes receiving, at a UE, a crowdsourced cell list based on location information of the UE from a crowdsourcing database. The crowdsourced cell list can be generated from a plurality of neighboring cell lists from a plurality of cellular networks. Further, the method can include selecting a cell from the crowdsourced cell list and camping on the selected cell.

In embodiments, selecting the cell from the crowdsourced cell list can include comparing the crowdsourced cell list to a neighboring cell list to identify one or more cells not identified in the neighboring cell list. Additionally, selecting the cell from the crowdsourced cell list can include selecting the cell from the one or more cells not identified in the neighboring cell list based on a radio access technology (RAT) priority list. According to embodiments, the selected cell may be associated with a fastest available RAT identified in the RAT priority list.

In some embodiments, camping on the selected cell can include releasing a connection to a cell currently camped on by the UE. Also, the method may include, in response to the UE camping on a first cell of a cellular network, transmitting the location information of the UE to the crowdsourcing database. Further, the method can include, in response to the UE moving a predetermined distance, transmitting the location information of the UE to the crowdsourcing database. According to embodiments, the location information of the UE may include global positioning system (GPS) coordinates of the UE and the crowdsourced cell list can be based on the GPS coordinates. Further, in embodiments, the location information of the UE can include a cell identifier identifying a first cell currently camped on by the UE and the crowdsourced cell list can be based on the cell identifier.

According to another embodiment, a method for crowdsourced cell selection includes receiving, at a crowdsourcing database, a respective neighboring cell list from a plurality of cellular networks. Additionally, the method can include determining a crowdsourced cell list from the received neighboring cell lists. Further, the method may include transmitting the crowdsourced cell list to a user equipment (UE) based on location information associated with the UE.

In embodiments, the location information may include GPS coordinates of the UE and the crowdsourced cell list can be transmitted to the UE based on the GPS coordinates. Further, in embodiments, the location information can include a cell identifier and the crowdsourced cell list can be transmitted to the UE based on the cell identifier.

Generally, in embodiments, UE includes a smartphone, tablet, mobile hotspot, personal computer, or router. Further, the UE can be configured to operate in an idle mode. As well, the UE may be configured to operate in a connected mode. Additionally, the UE can be configured to camp on a cell based on an operating mode of the UE. Also, the UE can be configured to camp on a cell based on an RAT associated with the cell. Further, the crowdsourcing database can be configured to periodically poll a cellular network for a neighboring cell list.

According to another embodiment, a system for crowdsourced cell selection includes a user equipment (UE) communicatively coupled to a crowdsourcing server. The UE can include one or more processors and a memory coupled to the one or more processors and storing executable instructions configured to manipulate the one or more processors to perform any method disclosed herein.

According to an embodiment, a system for crowdsourced cell selection includes a crowdsourcing database communicatively coupled to a user equipment (UE). The crowdsourcing server may include one or more processors and a memory coupled to the one or more processors and storing executable instructions configured to manipulate the one or more processors to perform any method disclosed herein.

### DETAILED DESCRIPTION

In response to camping on a new cell of a cellular network or moving a predetermined distance, a user equipment (UE) is configured to determine what other cells are available to help ensure that the UE is camped on a cell associated with a preferred (e.g., fastest available) radio access technology (RAT). To this end, in response to camping on a new cell of a cellular network or moving a predetermined distance, the UE sends location information (e.g., global positioning system (GPS) coordinates, cell identifiers, Wi-Fi position system (WPS) information (e.g., when GPS is not available)) associated with the UE to a crowdsourcing server. The crowdsourcing server is configured to generate crowdsourced cell lists based on neighboring cell lists collected from two or more cellular networks, UE, or both. By generating crowdsourced cell lists based on neighboring cell lists collected from two or more cellular networks, the crowdsourced cell lists generated by the crowdsourced database identify potentially available cells of one or more cellular networks within a predetermined distance of a location even if cells are omitted from one or more of the received neighboring cell lists due to, for example, a cellular network not being upgraded (e.g., legacy networks), a cellular network lacking a connection to another cellular network, a cellular network lacking the ability to handoff to a cellular network associated with a different RAT, or any combination thereof.

In response to receiving the location information from the UE, the crowdsourcing server selects a crowdsourced cell list for transmission based on the location information and transmits the crowdsourced cell list to the UE. That is to say, the crowdsourcing server transmits a crowdsourced cell list to the UE identifying potentially available cells within an area that includes the location indicated in the received location information. After receiving the crowdsourced cell list, the UE compares the crowdsourced cell list to one or more stored neighboring cell lists received from one or more cellular networks to determine if the crowdsourced cell list identifies any cells not identified in the neighboring cell lists. From the cells identified in the crowdsourced cell list but not in the neighboring cell lists, the UE selects a cell to camp on based on an RAT priority list. That is to say, the UE selects a cell from the cells identified in the crowdsourced cell list but not in the neighboring cell lists that is associated with the highest-ranked RAT in an RAT priority list. After selecting a cell, the UE then camps on the selected cell. In this way, the UE is configured to camp on a cell associated with the highest preferred RAT (e.g., the fastest available RAT) even if the cell is not identified (e.g., omitted) in the neighboring cell lists received from the cellular networks. Such omissions in neighboring cell lists arise from, for example, cellular networks not being upgraded (e.g., legacy networks), cellular networks lacking a connection to other cellular networks, cellular networks lacking the ability to handoff to a cellular network associated with a different RAT, or any combination thereof. As such, by using the crowdsourced cell list to select a cell to camp on, the user experience of the UE is improved as higher priority RATs (e.g., faster RATs) are more identifiable to the UE 102 even if they are omitted from received neighboring cell lists.

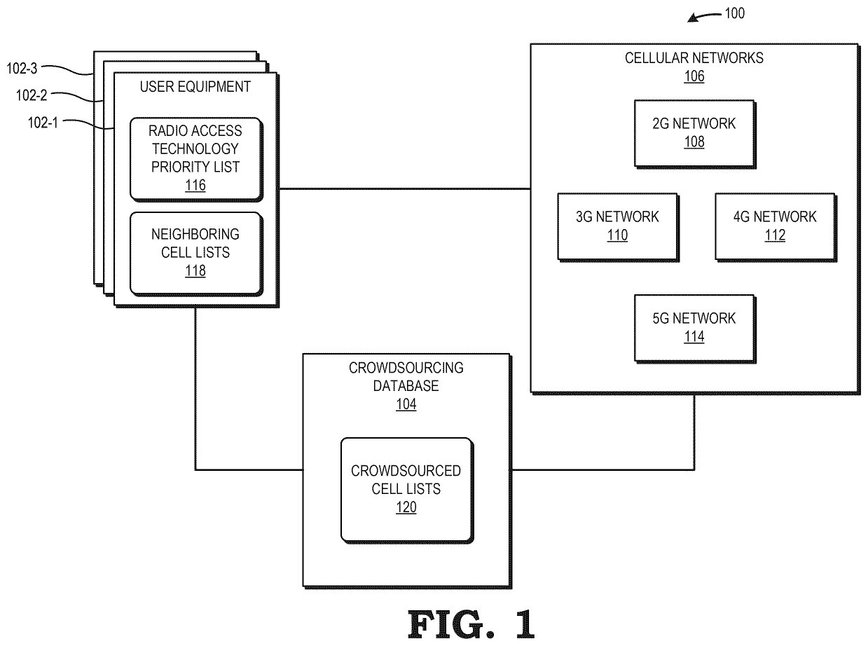

FIG. 1 illustrates a cellular networking framework 100 for crowdsourced cell selection for one or more UEs, according to embodiments. The framework 100 includes one or more cellular networks 106 each configured to transmit and receive data to and from one or more UEs 102. For example, framework 100 includes one or more 2G networks 108, one or more 3G networks 110, one or more 4G networks 112, one or more 5G networks 114, or any combination thereof, each configured to transmit and receive data to and from one or more UEs 102. To facilitate the transmission and reception of data to and from UEs 102, each cellular network 106 includes one or more cells each configured to transmit and receive data using one or more RATs. A cell includes, for example, mobile base station towers (e.g., “cell towers”), antennae, transmitters, receivers, digital signal processors, control electronics, Global Positioning System (GPS) receivers, base transceiver stations, or any combination thereof, configured to receive and transmit data to and from UE 102 using one or more RATs. Each RAT includes a physical connection method or protocol used to communicatively couple UEs 102 to one or more cellular networks 106, for example, 2G network connections (e.g., Global System for Mobile Communications (GSM) protocols, code division multiple access (CDMA) protocols, general packet radio service (GPRS) protocols, enhanced data rates for GSM evolution (EDGE) protocols), 3G network connections (e.g., Universal Mobile Telecommunications System (UMTS) protocols, wideband code division multiple access (W-CDMA) protocols, CDMA-200 protocols, high speed packet access (HSPA) protocols), 4G network communications (e.g., Long Term Evolution (LTE) protocols, Worldwide Interoperability for Microwave Access (WiMAX) protocols), 5G network communications (e.g., 5G New Radio (NR) protocols, 5G Technical Forum (5GTF) protocols, 5G Special Interest Group (5G-SIG) protocols), or any combination thereof. According to embodiments, each cellular network 106 is associated with a type (e.g., 2G, 3G, 4G, 5G) of network and uses RATs associated with its associated type of network. For example, referring to the example embodiment presented in FIG. 1, 2G network 108 uses 2G network communications, 3G network 110 uses 3G network communications, 4G network 112 uses 4G network communications, and 5G network 114 uses 5G network communications. Though the example embodiment presented in FIG. 1 presents one 2G network 108, one 3G network 110, one 4G network 112, and one 5G network 114, in other embodiments cellular network 106 can include any number of 2G, 3G, 4G, and 5G networks.

Each UE 102 is configured to communicatively couple to one or more cellular networks 106 by camping on one or more cells of a cellular network 106. Each UE 102 includes, for example, compute-enabled phones (“smartphones”), tablet computers, personal computers, laptop computers, Internet of Things (IoT) devices, GPS systems, routers, mobile hotspot devices, wearable devices, vehicle systems, or any combination thereof, to name a few. Though the example embodiment presented in FIG. 1 presents three UEs (102-1, 102-2, 102-3) connected to cellular networks 106, in other embodiments any number of UEs may be connected to cellular networks 106. In embodiments, a UE 102 camps on a cell of a cellular network 106 using an RAT associated with the cellular network 106. For example, a UE 102 camps on a cell of 3G network 110 using a 3G network communication (e.g., UMTS protocols, W-CDMA protocols, CDMA-200 protocols, HSPA protocols). According to embodiments, each UE 102 is configured to select a cell of a cellular network 106 to camp on based on an RAT associated with the cellular network 106. To select a cell of a cellular network 106 based on an associated RAT, each UE 102 includes an RAT priority list 116 that includes data representing priorities, preferences, conditions, or any combination thereof, for one or more RATs. For example, a RAT priority list 116 includes a preference listing, priority ranking, or both of one or more RATs based on one or more user inputs (e.g., inputs received at a UE 102, for example, gestures on a touchscreen, taps on a touchscreen, keystrokes, mouse clicks, or the like), user preferences, default settings, network settings, or any combination thereof, to name a few. That is to say, an RAT priority list 116 includes, for example, a ranking of one or more RATs according to respective preferences that are based on user inputs, user preferences, default settings, network settings, or any combination thereof. As another example, an RAT priority list 116 includes a ranking of one or more RATs based on the speeds (e.g., download speeds, upload speeds) of the RATs. In embodiments, a UE 102 selects a cell of a cellular network 106 to camp on based on an RAT ranking in an RAT priority list 116. For example, a UE 102 selects a cell of a cellular network 106 to camp on that uses the highest-ranked RAT in an RAT priority list 116.

To help ensure that a UE 102 is camped on a cell associated with the highest-ranked RAT in an RAT priority list 116, a UE 102 is configured to determine what cells of cellular networks 106 are potentially available to camp on in response to an RAT transfer event. An RAT transfer event includes, for example, a UE 102 camping on a new cell of a cellular network 106, a UE 102 moving a predetermined distance, or both. As an example, an RAT transfer event includes a UE 102 determining it has moved a predetermined distance based on, for example, GPS coordinates. In embodiments, to determine which cells of cellular networks 106 are potentially available to camp on, each UE 102 uses one or more respective neighboring cell lists 118. A neighboring cell list 118 includes, for example, data indicating one or more potentially available cells of one or more cellular networks 106. For example, a neighboring cell list 180 includes data representing respective frequencies indicating one or more potentially available cells of one or more cellular networks 106. In embodiments, a UE 102 is configured to receive a neighboring cell list 118 from a cell of a cellular network 106 on which the UE 102 is camped. That is to say, the UE 102 receives a neighboring cell list 118 from a cellular network 106 that the UE 102 is communicatively coupled to. According to embodiments, a neighboring cell list 118 received from such a cellular network 106 includes, for example, data indicating one or more available cells of one or more cellular networks 106 within a predetermined distance from a cell of the reporting cellular network (e.g., the cell upon which the UE 102 is camped). In some embodiments, a cellular network 106 sends one or more neighboring cell lists 118 each indicating the cells of cellular networks 106 associated with the same RAT while in other embodiments, the cellular network 106 sends one or more neighboring cell lists 118 each indicating the cells of cellular networks 106 associated with two or more RATs.

In embodiments, one or more cellular networks 106 are configured to send one or more neighboring cell lists 118 to crowdsourcing database 104. Crowdsourcing database 104 includes one or more physical servers, virtual servers, or both configured to store one or more neighboring cell lists 118 from one or more cellular networks 106. For example, crowdsourcing database 104 is configured to periodically request (e.g., based on a predetermined interval of seconds, minutes, hours, days, weeks, months, years, or any combination thereof) neighboring cell lists 118 from one or more cellular networks 106 and, in response to receiving a neighboring cell list 118, store the neighboring cell list 118. Further, according to embodiments, one or more UEs 102 are configured to send one or more neighboring cell lists 118 (e.g., those received from cellular networks 106, crowdsourced cell lists 120 received from one or more crowdsourcing databases 104) to crowdsourcing database 104. In response to receiving a neighboring cell list 118 from a UE 102, crowdsourcing database 104 stores the neighboring cell list 118. In embodiments, crowdsourcing database 104 is configured to generate one or more crowdsourced cell lists 120 based on one or more stored neighboring cell lists 118. For example, in response to receiving one or more neighboring cell lists 118, crowdsourcing database 104 is configured to generate a crowdsourced cell list 120 that includes data representing one or more potentially available cells of one or more cellular networks 106 based on the potentially available cells identified in the stored neighboring cell lists 118. As an example, crowdsourcing database 104 is configured to generate a crowdsourced cell 120 that includes respective frequencies representing one or more potentially available cells of cellular networks 106. In embodiments, a crowdsourced cell list 120 further identifies one or more RATs associated with one or more cellular networks 106. For example, a crowdsourced cell list 120 identifies one or more potentially available cells of one or more cellular networks 106 each associated with one or more respective RATs. A crowdsourced cell list 120 further identifies one or more potentially available cells of one or more cellular networks 106 relative to a location. For example, a crowdsourced cell list 120 identifies one or more potentially available cells of one or more cellular networks 106 within a predetermined distance from a determined location. A predetermined distance represents, for example, the range of one or more cells of one or more cellular networks 106 and a determined location represents, for example, the location of a cell of a cellular network 106, the location of a UE 102, a predetermined location, an averaged location of one or more cells, or any combination thereof, to name a few. As another example, a crowdsourced cell list 120 identifies one or more potentially available cells of one or more cellular networks 106 each associated with a respective RAT within a radius (e.g., a predetermined distance) from a predetermined location. In generating the crowdsourced cell lists 120 in this way, the crowdsourced cell lists 120 makes the potentially available cells of one or more cellular networks 106 more readily identifiable to a UE 102 when compared to a neighboring cell list 118 received from a cellular network 106. For example, a crowdsourced cell list 120 lists cells of cellular networks 106 even when they are omitted from one or more neighboring cell lists 118 used to generate the crowdsourced cell list due to, for example, a cellular network not being upgraded (e.g., legacy networks), a cellular network lacking a connection to another cellular network, a cellular network lacking the ability to handoff to a cellular network associated with a different RAT, or any combination thereof. As another example, a crowdsourced cell list 120 identifying potentially available cells within a predetermined distance of an averaged location (e.g., an averaged location of one or more cells identified in a crowdsourced cell list 120) helps to more accurately identify potentially available cells to a UE 102 that is actively moving or has moved.

According to embodiments, one or more UEs 102 are configured to determine which cellular networks 106 are available to camp on by requesting one or more crowdsourced cell lists 120 from crowdsourcing database 104. For example, in response to an RAT transfer event (e.g., a UE 102 moving a predetermined distance, a UE 102 camping on a new cell), a UE 102 is configured to provide a cell identifier (e.g., data identifying one or more cells of a cellular network) of a cell the UE 102 is currently camped on, a cell identifier of a cell the UE 102 was previously camped on, GPS coordinates of the UE 102 (e.g., GPS latitude, GPS longitude), WPS information of the UE 102 (e.g., when GPS is not available), or any combination thereof to crowdsourcing database 104. In response to receiving the GPS coordinates, cell identifiers, or both, crowdsourcing database 104 is configured to select a crowdsourced cell list 120 based on the location indicated by the GPS coordinates, cell identifiers, or both. As an example, in response to receiving GPS coordinates from a UE 102, crowdsourcing database 104 is configured to select a crowdsourced cell list 120 identifying potentially available cells of one or more cellular networks 106 within a predetermined distance from a location that is the same as the location indicated in the GPS coordinates, nearest to the location indicated in the GPS coordinates, within a threshold distance from the location indicated in the GPS coordinates, having a signal strength over a predetermined threshold value at the location indicated in the GPS coordinates, or any combination thereof. For another example, in response to receiving a cell identifier from a UE 102 (e.g., data identifying a cell the UE 102 is currently camped on, data identifying a cell the UE 102 was previously camped on, or both), crowdsourcing database 104 is configured to select a crowdsourced cell list 120 identifying available cells of one or more cellular networks 106 within a predetermined distance from a location that is the same as the location of one or more cells indicated in the cell identifier, nearest to the location of one or more cells indicated in the cell identifier, within a threshold distance from the location of one or more cells indicated in the cell identifier, having signal a strength over a predetermined threshold value at the location of one or more cells indicated in the cell identifier, or any combination thereof.

Based on a crowdsourced cell list 120 received from crowdsourcing database 104, the UE 102 determines which cells of one or more cellular networks are potentially available to camp on. According to embodiments, the UE 102 is configured to compare a received crowdsourced cell list 120 to one or more neighboring cell lists 118 received from one or more cellular networks 106. For example, the UE 102 is configured to compare a crowdsourced cell list 120 to one or more neighboring cell lists 118 to determine if the crowdsourced cell list 120 identifies one or more cells not indicated or identified in the neighboring cell lists 118. In response to determining that the crowdsourced cell list 120 identifies one or more cells not indicated in the neighboring cell lists 118, the UE 102 then selects one of the cells not indicated in the neighboring cell lists 118 to camp on based on a respective RAT priority list 116. As an example, the UE 102 selects a cell from the cells not indicated in the neighboring cells lists 118 that is associated with a higher preferred RAT than the cells listed in the neighboring cell lists 118. As such, the UE 102 camps on a cell associated with the highest preferred RAT (e.g., the fastest available RAT) even if a cellular network 106 does not list the cell in its provided neighboring cell list 118 due to the cellular network, for example, not being upgraded (e.g., a legacy network), lacking a connection to another cellular network 106, or lacking the ability to handoff to another cellular network 106 associated with another RAT. In this way, user experience is improved as higher priority RATs (e.g., faster RATs) are more identifiable to the UE 102.

According to embodiments, in response to selecting a cell from neighboring cell lists 118, crowdsourced cell list 120, or both, the UE 102 is configured to determine if the selected cell is available to camp on, qualified to camp on, or both. To determine if a selected cell is available to camp on, qualified to camp on, or both, the UE 102 is configured to perform a measurement of the frequency of the selected cell. As an example, the UE 102 compares the measured frequency of a selected cell to a predetermined threshold value. In response to the frequency matching or exceeding the threshold value, the UE 102 determines that the selected cell is available to camp on, qualified to camp on, or both. In response to the frequency being less than the threshold value, the UE 102 determines that the selected cell is not available or qualified to camp on. If the selected cell is available to camp on, qualified to camp on, or both, the UE 102 communicatively couples to the cell using an RAT associated with the cell. If the selected cell is not available to camp on, qualified to camp on, or both, then the UE 102 selects another cell from neighboring cell lists 118, crowdsourced cell list 120, or both to camp on.

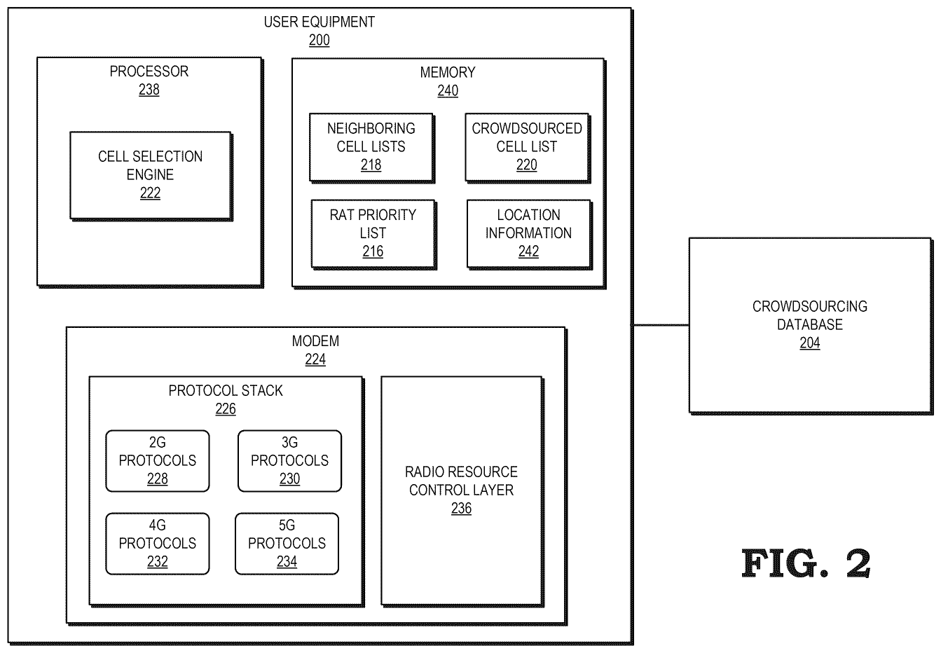

Referring now to FIG. 2, a UE 200 using crowdsourced cell selection is presented. UE 200, similar to or the same as a UE 102, includes processor 238 and a modem 224 configured to communicatively couple to one or more cellular networks 106. In embodiments, to communicatively couple to one or more cellular networks 106, modem 224 includes a radio resource control (RRC) layer 236 that includes hardware and software configured to, for example, establish a connection between UE 200 and one or more cellular networks 106, broadcast system information related to UE 200, release UE 200 from a connected cellular network 106, or any combination thereof. For example, RRC layer 236 is configured to establish a connection between UE 200 and a cell of a cellular network 106 such that UE 200 is camped on the cell. In embodiments, RRC layer 236 is configured to establish a connection between a cell of a cellular network 106 and UE 200 using protocol stack 226. Protocol stack 226 includes hardware and software configured to communicatively couple to (e.g., camp on) a cell of a cellular network 106, transmit data to a cell of a cellular network 106, receive data from a cell of a cellular network 106, or any combination thereof using one or more RATs associated with a type of cellular network (e.g., 2G, 3G, 4G, 5G). For example, protocol stack 226 includes hardware and software configured to camp on a cell of a cellular network 106 using 2G protocols 228 (e.g., protocols or RATs associated with 2G networks), 3G protocols 230 (e.g., protocols or RATs associated with 3G networks), 4G protocols 232 (e.g., protocols or RATs associated with 4G networks), and 5G protocols 234 (e.g., protocols or RATs associated with 5G networks).

According to embodiments, UE 200 is configured to receive one or more neighboring cell lists 218, the same as or similar to neighboring cell lists 118, from one or more cells of cellular networks 106 currently communicatively coupled to UE 200, one or more cells of cellular networks 106 previously communicatively coupled to UE 200, or both. Each neighboring cell list 218 includes data identifying, for example, one or more potentially available cells of one or more cellular networks 106 within a predetermined distance (e.g., a range of one or cells) from a cell currently communicatively coupled to UE 200, previously communicatively coupled to UE 200, or both. UE 200 includes memory 240 configured to store one or more received neighboring cells lists 218. Memory 240 includes, for example, a hard-disk drive (HDD), solid-state memory, flash memory, random-access memory (RAM), read-only memory (ROM), programmable read-only memory (PROM), electronically erasable programmable read-only memory (EEPROM), or any combination thereof, to name a few. In embodiments, UE 200 is configured to transmit one or more neighboring cell lists 218 to crowdsourcing database 204 (e.g., periodically send based on a predetermined amount of time).

To select a cell of a cellular network 106 to camp on or connect to, UE 200 includes cell selection engine 222 software configured to select a cell of a cellular network 106 to camp on based on one or more neighboring cell lists 218. For example, cell selection engine 222 is configured to select a cell from one or more neighboring cell lists 218 based on an RAT priority list 216, the same as or similar to RAT priority list 116, stored in memory 240. RAT priority list 216 includes, for example, data representing priorities, preferences, conditions, or any combination thereof, for one or more RATs. For example, RAT priority list 216 includes, for example, a ranking of one or more RATs according to respective preferences that are based on user inputs, user preferences, default settings, network settings, or any combination thereof. As another example, RAT priority list 216 includes a ranking of one or more RATs based on the speeds (e.g., download speeds, upload speeds) of the RATs. In embodiments, cell selection engine 222 is configured to select a cell from one or more neighboring cell lists 218 associated with the RAT ranked highest (e.g., having the highest priority) in RAT priority list 216. For example, based on an RAT priority list 216 ranking RATs by speed, RAT selection engine selects a cell associated with 4G protocols from a neighboring cell list 218 identifying cells of 3G and 4G networks. That is to say, cell selection engine 222 selects a cell associated with the fastest available RAT from one or more neighboring cell lists 218 based on an RAT priority list 216 ranking RATs by speed. In response to cell selection engine 222 selecting a cell from one or more neighboring cell lists 218, RRC layer 236 is configured to camp on the connected cell using one or more protocols (e.g., RATs) from protocol stack 226 associated with the selected cell.

In embodiments, UE 200 is configured to receive one or more crowdsourced cell lists 220, similar to or the same as crowdsourced cell lists 120, from crowdsourcing database 204, similar to or the same as crowdsourcing database 104. According to embodiments, in response to an RAT transfer event, UE 200 is configured to request a crowdsourced cell list 220 from crowdsourcing database 204 by transmitting location information 242 to crowdsourcing database 204 via one or more cellular networks 106, Wi-Fi, Bluetooth, near-field communication, or any combination thereof. Such location information 242 includes, for example, a cell identifier (e.g., data identifying one or more cells of a cellular network) of a cell UE 200 is currently camped on, a cell identifier of a cell UE 200 was previously camped on, GPS coordinates of UE 200 (e.g., GPS latitude, GPS longitude), or any combination thereof. In response to receiving location information 242, crowdsourcing database 204 is configured to transmit a crowdsourced cell list 220 to UE 200 based on the location indicated by location information 242. As an example, in response to receiving location information 242 including GPS coordinates, crowdsourcing database 204 is configured to transmit a crowdsourced cell list 220 identifying available cells of one or more cellular networks 106 within a predetermined distance from a location that is the same as the location indicated in the GPS coordinates, nearest to the location indicated in the GPS coordinates, within a threshold distance from the location indicated in the GPS coordinates, having a signal strength over a predetermined threshold value at the location indicated in the GPS coordinates, or any combination thereof. For another example, in response to receiving location information 242 including a cell identifier (e.g., data identifying a cell UE 200 is currently camped on, data identifying a cell UE 200 was previously camped on, or both), crowdsourcing database 204 is configured to transmit a crowdsourced cell list 220 identifying available cells of one or more cellular networks 106 within a predetermined distance from a location that is the same as the location of one or more cells indicated in the cell identifier, nearest to the location of one or more cells indicated in the cell identifier, within a threshold distance from the location of one or more cells indicated in the cell identifier, having a signal strength over a predetermined threshold value at the location of one or more cells indicated in the cell identifier, or any combination thereof. In response to receiving a crowdsourced cell list 220 from crowdsourcing database 204, UE 200 stores the received crowdsourced cell list 220 in memory 240.

According to embodiments, cell selection engine 222 is configured to select a cell to camp on from the cells identified in one or more crowdsourced cell lists 220 stored in memory 240. For example, cell selection engine 222 is configured to compare one or more crowdsourced cell lists 220 to one or more stored neighboring cell lists 218 to determine if the crowdsourced cell lists 220 identify any cells not identified in the stored neighboring cell lists 218. In embodiments, in response to determining that one or more crowdsourced cell lists 220 identify cells not identified in the stored neighboring cell lists 218, cell selection engine 222 is configured to select one of the cells not identified in the stored neighboring cell lists 218 based on RAT priority list 216. For example, cell selection engine 222 is configured to determine if any of the cells not identified in the stored neighboring cell lists 218 are associated with an RAT having a higher priority (e.g., higher ranking) in the RAT priority list 216 than the cell UE 200 is currently camped on, the cells listed in the neighboring cell lists 218, or both. In response to determining that at least one of the cells not identified in the stored neighboring cell lists 218 is associated with an RAT having a higher priority, the cell selection engine 222 then selects one of these cells to camp on. In this way, cell selection engine 222 is configured to select a cell from either neighboring cell lists 218 or crowdsourced cell list 220 that is associated with an RAT having the highest priority (e.g., higher ranking) in the RAT priority list 216. As an example, in response to RAT priority list 216 ranking RAT priorities by speeds of the RATs, cell selection engine 222 is configured to select a cell from either neighboring cell lists 218 or crowdsourced cell list 220 that is associated with the fastest available RAT. In response to cell selection engine 222 selecting a cell from neighboring cell lists 218, crowdsourced cell list 220, or both, RRC layer 236 is configured to determine if the cell is available to camp on, qualified to camp on, or both. For example, UE 200 is configured to perform a measurement of the frequency of a selected cell to determine that the selected cell is available to camp on, qualified to camp on, or both. UE 200 then compares the measured frequency of a selected cell to a predetermined threshold value. In response to the frequency matching or exceeding the threshold value, UE 200 determines that the selected cell is available to camp on, qualified to camp on, or both. In response to the frequency being less than the threshold value, UE 200 determines that the selected cell is not available or qualified to camp on. If the selected cell is available to camp on, qualified to camp on, or both, RRC layer 236 camps on the selected cell using one or more protocols (e.g., RATs) from protocol stack 226 associated with the selected cell. If the selected cell is not available to camp on, then cell selection engine 222 selects another cell from neighboring cell lists 218, crowdsourced cell list 220, or both.

In embodiments, RRC layer 236 is configured to camp on a selected cell based upon the operating mode of UE 200. The operating mode of UE 200 is based on, for example, the current connection status between UE 200 and one or more cells of a cellular network 106. As an example, when not currently connected to or camped on a cell of a cellular network 106, UE 200 operates in an idle mode. While operating in an idle mode, connections between UE 200 and one or more cells of one or more cellular networks 106 are performed by RRC layer 236 with RRC layer 236 directly camping on a cell of a cellular network 106. As another example, when currently camped on a cell of a cellular network 106, UE 200 operates in a connected mode. While operating in the connected mode, connections between UE 200 and one or more cells of one or more cellular networks 106 are performed by the cellular network 106 currently camped on. For example, to camp on a cell of a second cellular network 106, the first cellular network 106 UE 200 is currently camped on performs a handoff to the second cellular network 106. According to embodiments, to camp on a cell selected from neighboring cell lists 218 or crowdsourced cell lists 220 while UE 200 is operating in an idle mode, RRC layer 236 is configured to perform, for example, a background search, cell reselection, or both to camp on the selected cell. Further, to camp on a cell selected from neighboring cell lists 218 or crowdsourced cell lists 220 while UE 200 is operating in a connected mode, RRC layer 236 is configured to perform, for example, a scan to determine the selected cell is available to camp on, a local release of the currently connected cell, or both to camp on the selected cell.

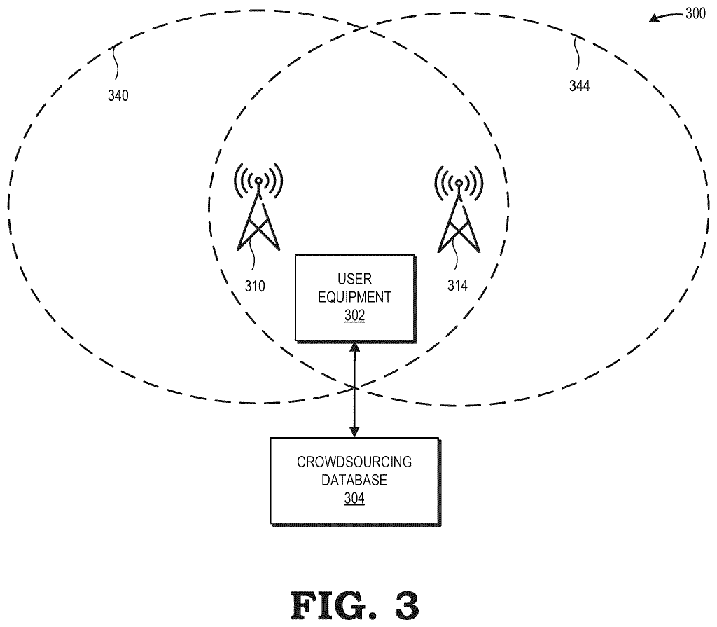

Referring now to FIG. 3, an example framework 300 for crowdsourced cell selection is presented. In an example embodiment, a UE 302, the same as or similar to UE 102, UE 200, is camped on a cell of cellular network 310, similar to or the same as 3G network 110, associated with one or more 3G RATs (e.g., protocols). According to embodiments, cellular network 310 has a coverage 340 (e.g., the maximum distance at which one or more cells of cellular network 310 are available or qualified to be camped on). In an example embodiment, the UE 302 is configured to move to a location within both coverage 340 of cellular network 310 and coverage 344 of cellular network 314, similar to or the same as 5G network 114, associated with one or more 5G RATs (e.g., protocols). Coverage 344 represents, for example, the maximum distance at which one or more cells of cellular network 314 are available to be camped on. In the example embodiment, cellular network 310 provides the UE 302 with one or more neighboring cell lists, the same as or similar to neighboring cell lists 118, 218, that do not identify one or more cells of cellular network 314.

To determine what cells are available to camp on, the UE 302 is configured to provide location information, the same as or similar to location information 242, indicating the location of UE 302 to crowdsourcing database 304, the same as or similar to crowdsourcing database 104, 204. Such location information includes, for example, a cell identifier identifying the cell of cellular network 310 the UE 302 is currently camped on, a cell identifier identifying a cell the UE 302 was previously camped on, GPS coordinates of the UE 302 (e.g., GPS latitude, GPS longitude), or any combination thereof. In response to receiving the location information from the UE 302, crowdsourcing database 304 is configured to transmit one or more crowdsourced cell lists, the same as or similar to crowdsourced cell lists 120, 220, based on the received location information. For example, in response to receiving location information including a cell identifier of a cell of cellular network 310, crowdsourcing database 304 is configured to transmit a crowdsourced cell list identifying available cells of one or more cellular networks within a predetermined distance from a location that is the same as the location of the cell of cellular network 310, nearest to the location of the cell of cellular network 310, within a threshold distance from the location of the cell of cellular network 310, having a signal strength over a predetermined threshold value at the location of the cell of cellular network 310, or any combination thereof. As another example, in response to receiving location information including GPS coordinates of the UE 302, crowdsourcing database 304 is configured to provide a crowdsourced cell list identifying available cells of one or more cellular networks within a predetermined distance from the location indicated by the GPS coordinates, nearest to the location indicated by the GPS coordinates, within a threshold distance from the location indicated by the GPS coordinates, having a signal strength over a predetermined threshold value at the location indicated by the GPS coordinates, or any combination thereof. In the example embodiment present in FIG. 3, crowdsourcing database 304 is configured to provide a crowdsourced cell list identifying one or more cells of cellular network 310, cellular network 314, or both.

In response to receiving one or more crowdsourced cell lists from crowdsourcing database 304, the UE 302 is configured to determine what cells are potentially available to camp on. For example, the UE 302 is configured to compare one or more received crowdsource cells lists to one or more neighboring cell lists to determine if there are cells identified in the crowdsourced cell list that are not identified in the neighboring cell lists. In response to determining there are cells identified in the crowdsourced cell list that are not identified in the neighboring cell lists, the UE 302 is configured to select one of the cells not identified in the neighboring cell lists to camp on based on a RAT priority list, the same as or similar to RAT priority list 116, 216. For example, the UE 302 is configured to select a cell from the cells not identified in the neighboring cell lists that are associated with the highest priority (e.g., highest ranked) RAT indicated in the RAT priority list. As an example, the UE 302 is configured to select a cell from the cell not identified in the neighboring cell lists that is associated with the fastest available RAT based on an RAT priority list that ranks RAT priority by the speed of the RATs. In the example embodiment presented in FIG. 3, the UE 302 is configured to select one or more cells of cellular network 314 based on an RAT priority list that ranks RAT priority by the speed of the RATs as cellular network 314 is associated with a faster RAT (e.g., 5G) than cellular network 310 (e.g., 3G).

According to embodiments, the UE 302 is configured to camp on the selected cell based on the current operating mode of the UE 302 (e.g., idle operating mode, connected operating mode). While in an idle operating mode, the UE 302 is configured to, for example, perform a background search, cell reselection, or both to camp on the selected cell. Further, while in a connected operating mode, the UE 302 is configured to, for example, perform a scan to determine the selected cell is available to camp on, a local release of the currently connected cell, or both to camp on the selected cell.

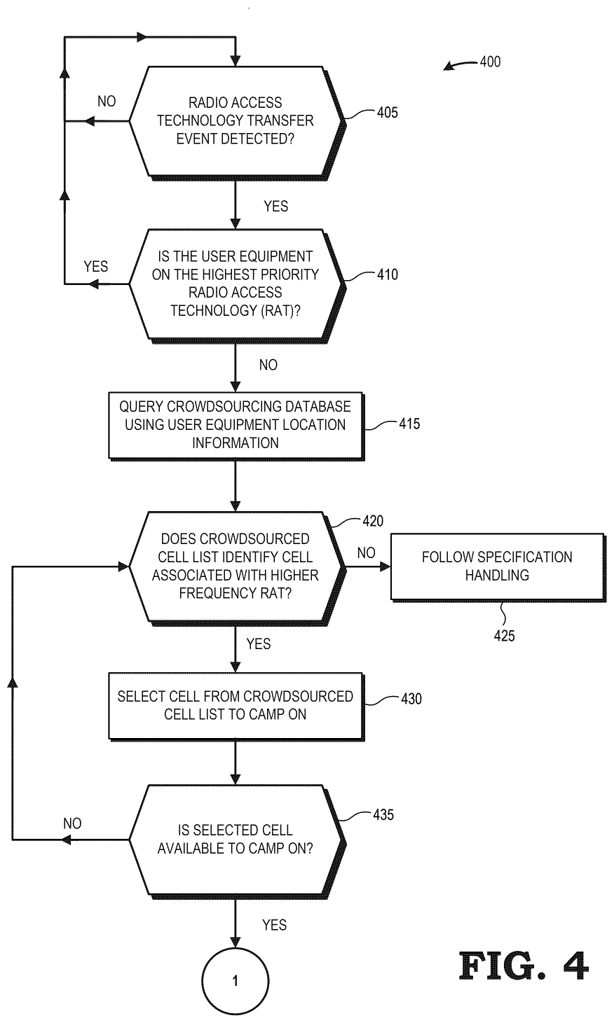

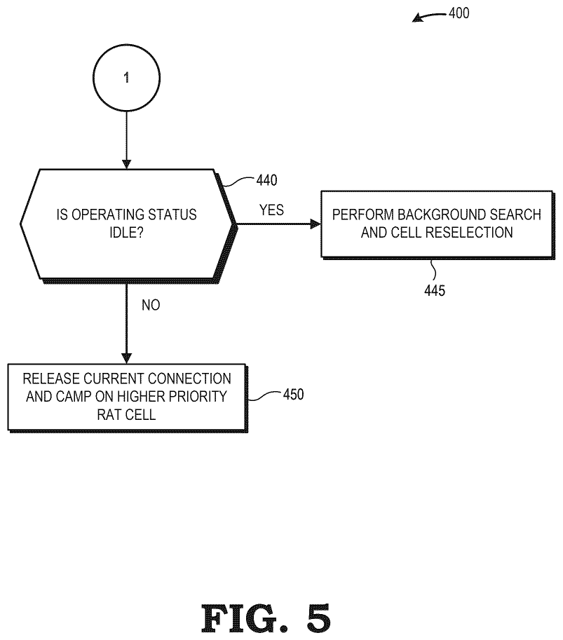

Referring now to FIGS. 4 and 5, FIGS. 4 and 5 together present an example method 400 for crowdsourced cell selection, according to an example embodiment. At block 405, a UE, the same as or similar to UE 102, 200, 302, determines if an RAT transfer event has occurred. An RAT transfer event includes, for example, the UE camping on a new cell of a cellular network, similar to or the same as cellular networks 106, moving a predetermined distance, or both. In response to determining that a RAT transfer event has occurred, the system moves to block 410. In response to determining that no RAT transfer even has occurred, the system repeats block 405. At block 410, the UE determines if the cell currently camped on is associated with the highest priority RAT listed in a RAT priority list, the same as or similar to RAT priority list 116, 216. For example, based on a RAT priority list ranking the priority of RATs by speed, the UE determines if the cell currently camped on is associated with the fastest available RAT identified in the RAT priority list. In response to the UE determining that the cell is associated with the highest priority RAT listed in a RAT priority list, the system goes back to block 405. In response to the UE determining that the cell is not associated with the highest priority RAT listed in a RAT priority list, the system moves to block 415.

At block 415, the UE queries a crowdsourcing database, the same as or similar to crowdsourcing database 104, 204, 304, for one or more crowdsourced cell lists, the same as or similar to crowdsourced cell lists 120, 220. For example, the UE transmits location information, the same as or similar to location information 242, to the crowdsourcing database. The location information includes, for example, a cell identifier (e.g., data identifying one or more cells of a cellular network) of a cell that the UE is currently camped on, a cell identifier of a cell that the UE was previously camped on, GPS coordinates of the UE, or any combination thereof. In response to receiving the location information, the crowdsourcing database transmits one or more crowdsourced cell lists based on the location information. For example, in response to receiving location information including GPS coordinates of the UE, the crowdsourcing database selects a crowdsourced cell list for transmission that identifies available cells of one or more cellular networks within a predetermined distance from a location that is the same as the location indicated in the GPS coordinates, nearest to the location indicated in the GPS coordinates, within a threshold distance from the location indicated in the GPS coordinates, having a signal strength over a predetermined threshold value at the location indicated by the GPS coordinates, or any combination thereof. For another example, in response to receiving location information including a cell identifier identifying the cell the UE is currently camped on, the crowdsourcing database selects a crowdsourced cell list identifying available cells of one or more cellular networks within a predetermined distance from a location that is the same as the location of the identified cell, nearest to the location of the identified cell, within a threshold distance from the location of the identified cell, having a signal strength over a predetermined threshold value at the location the identified cell, or any combination thereof. In response to selecting a crowdsourced cell list for transmission, the crowdsourcing database transmits the selected crowdsourced cell list to the UE.

At block 420, the UE determines if the received crowdsourced cell list identifies one or more cells associated with one or more higher priority RATs (e.g., based on the RAT priority list) than the cell currently camped on, the cells listed in on or more neighboring cell lists received from one or more cellular networks, or both. For example, the UE compares a received crowdsourced cell list to one or more neighboring cell lists to determine if the crowdsourced cell list identifies cells not identified in the neighboring cell lists. In response to determining that the crowdsourced cell list identifies cells not identified in the neighboring cell lists, the UE determines if any of the cells not identified in the neighboring cell lists are associated with an RAT having a higher priority than the cell currently camped on, the cells listed in the neighboring cell lists, or both based on the RAT priority list. For example, based on an RAT priority list ranking RATs by speed, the UE determines if any of the cells not identified in the neighboring cell lists are associated with RATs that are faster than the RATs associated with the cell currently camped on, the cells listed in the neighboring cell lists, or both. In response to determining that any of the cells not identified in the neighboring cell lists are associated with an RAT having a higher priority than the cell currently camped on, the cells listed in the neighboring cell lists, or both, the system moves to block 430. In response to determining that none of the cells not identified in the neighboring cell lists are associated with an RAT having a higher priority than the cell currently camped on, the cells listed in the neighboring cell lists, or both, the system moves to block 425. At block 425, the UE, for example, follows handling procedures according to one or more specifications, for example, the 3rd Generation Partnership Project (3GPP) specification.

At block 430, the UE selects a cell from the crowdsourced cell list based on, for example, the RAT priority cell list, location of the cell, signal strength of the cell, or any combination thereof. For example, the UE selects a cell from the crowdsourced cell list associated with the RAT having the highest preference (e.g., ranking) in the RAT priority list. As an example, based on an RAT priority list ranking the preference of RATs by speed, the UE selects a cell from the crowdsourced cell list associated with the fastest available RAT. At block 435, in response to selecting a cell from the crowdsourced cell list, the UE determines if the selected cell is available to camp on. For example, the UE performs a measurement of the frequency of the selected cell to determine if the selected cell is available and qualified to camp on. To this end, the UE compares the measured frequency to a predetermined threshold value. In response to the frequency matching or exceeding the threshold value, the UE determines that the selected cell is available and qualified to camp on. In response to the frequency being less than the threshold value, the UE determines that the selected cell is not available or qualified to camp on. In response to determining that the selected cell is available and qualified to camp on, the system moves to block 440. In response to determining that the selected cell is not available or qualified to camp on, the UE flags the cell as currently unavailable, flags the cell as currently unqualified, or both, and the system repeats block 420 with the remaining cells (e.g., those not marked as unavailable or unqualified) identified in the crowdsourced cell list.

At block 440, the UE is configured to camp on the selected cell based on the operating mode (e.g., idle mode, connected mode) of the UE. For example, the UE determines if its operation status is idle. In response to the UE operating in an idle mode, the system moves to block 445, and the UE performs a background search and cell reselection to camp on the selected cell. In response to the UE not operating in an idle mode (e.g., operating in a connected mode), the system moves to block 450. At block 450, the UE releases the current connection to a cell (e.g., the cell the UE is currently camped on) to camp on the selected cell. In embodiments, before releasing the current connection to a cell, the UE is configured to measure the frequency of the selected cell and compare the measured frequency to a predetermined threshold value. In response to the measured frequency being less than the predetermined threshold value (e.g., indicating the signal strength of the selected cell is not strong enough for connection), the system repeats block 420 with another cell identified in the crowdsourced cell list. In response to the measured frequency being equal to or greater than the predetermined threshold value (e.g., indicating the signal strength of the selected cell is strong enough for connection), the UE camps on the selected cell.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method for crowdsourced cell selection comprising:
receiving, at a user equipment (UE), a crowdsourced cell list based on location information of the UE from a crowdsourcing database, wherein the crowdsourced cell list is generated from a plurality of neighboring cell lists from a plurality of cellular networks;
selecting a cell from the crowdsourced cell list; and
camping on the selected cell.

2. The method of claim 1, wherein selecting the cell from the crowdsourced cell list comprises:
comparing the crowdsourced cell list to a neighboring cell list to identify one or more cells not identified in the neighboring cell list; and
selecting the cell from the one or more cells not identified in the neighboring cell list based on a radio access technology (RAT) priority list.

3. The method of claim 2, wherein the selected cell is associated with a fastest available RAT identified in the RAT priority list.

4. The method of claim 1, wherein camping on the selected cell comprises:
releasing a connection to a cell currently camped on by the UE.

5. The method of claim 1, further comprising:
in response to the UE camping on a first cell of a cellular network, transmitting the location information of the UE to the crowdsourcing database.

6. The method of claim 1, further comprising:
in response to the UE moving a predetermined distance, transmitting the location information of the UE to the crowdsourcing database.

7. The method of claim 1, wherein the location information of the UE includes global positioning system (GPS) coordinates of the UE and wherein the crowdsourced cell list is based on the GPS coordinates.

8. The method of claim 1, wherein the location information of the UE includes a cell identifier identifying a first cell currently camped on by the UE and wherein the crowdsourced cell list is based on the cell identifier.

9. A method for crowdsourced cell selection comprising:
receiving, at a crowdsourcing database, a respective neighboring cell list from a plurality of cellular networks;
determining a crowdsourced cell list from the received neighboring cell lists; and
transmitting the crowdsourced cell list to a user equipment (UE) based on location information associated with the UE.

10. The method of claim 9, wherein the location information includes GPS coordinates of the UE and wherein the crowdsourced cell list is transmitted to the UE based on the GPS coordinates.

11. The method of claim 9, wherein the location information includes a cell identifier and wherein the crowdsourced cell list is transmitted to the UE based on the cell identifier.

12. The method of claim 1, wherein the UE comprises a smartphone.

13. The method of claim 1, wherein the UE comprises a tablet, mobile hotspot, personal computer, or router.

14. The method of claim 1, wherein the UE is configured to operate in an idle mode.

15. The method of claim 1, wherein the UE is configured to operate in a connected mode.

16. The method of claim 1, wherein the UE is configured to camp on a cell based on an operating mode of the UE.

17. The method of claim 1, wherein the UE is configured to camp on a cell based on an RAT associated with the cell.

18. The method of claim 1, wherein the crowdsourcing database is configured to periodically poll a cellular network for a neighboring cell list.

19. A system for crowdsourced cell selection, the system comprising:
a user equipment (UE) communicatively coupled to a crowdsourcing server and including:
one or more processors; and
a memory coupled to the one or more processors and storing executable instructions configured to manipulate the one or more processors to:
receive, at the UE, a crowdsourced cell list based on location information of the UE from a crowdsourcing database, wherein the crowdsourced cell list is generated from a plurality of neighboring cell lists from a plurality of cellular networks;
select a cell from the crowdsourced cell list; and
camp on the selected cell.

20. A system for crowdsourced cell selection, the system comprising:
a crowdsourcing database communicatively coupled to a user equipment (UE) and including:
one or more processors; and
a memory coupled to the one or more processors and storing executable instructions configured to manipulate the one or more processors to:
receive, at the crowdsourcing database, a respective neighboring cell list from a plurality of cellular networks;
determine a crowdsourced cell list from the received neighboring cell lists; and
transmit the crowdsourced cell list to the UE based on location information associated with the UE.
